(19) United States
(12) Patent Application Publication
(10) Pub. No.: US 2009/0188866 A1
(43) Pub. Date: Jul. 30, 2009

(54) Desalination with production of brine fuel

(76) Inventor: Benjamin Elias Blumenthal, Atlanta, GA (US)

Correspondence Address: Benjamin Blumenthal, 1669 Mason Mill Road, Atlanta, GA, 30329, US

(21) Appl. No.: 12/011,229

(22) Filed: Jan. 25, 2008

(51) Int. Cl. B01D 61/02; C02F 1/58; B01D 61/06

(52) U.S. Cl. 210/652; 210/170.11

(57) ABSTRACT

The present invention involves a water-based vessel for the production of desalinated water and concentrated brine. The former is usable for drinking water in areas that lack sufficient potable water, while the latter may be used as fuel in electricity production. The invention additionally includes capabilities of providing electricity, food, and lodging in response to emergency conditions.

### BACKGROUND OF THE INVENTION

1. Field of the Invention

The present invention provides for a way of producing desalinated water in an environmentally-responsible and economically feasible manner. Specifically, unlike most desalination systems which discharge concentrated salt water back into the water source, usually the ocean, the present invention makes use of concentrated “waste” brine for alternative uses including but not limited to electrical power-plant fuel.

2. Description of the Related Art

Drinking water is a precious commodity. Throughout the world, drought, urban overexpansion and lack of rain have contributed to significant shortages of drinkable water. Cities such as Atlanta and countries such as Israel have watched as their natural water resources have diminished precipitously in light of high demand and modest precipitation. The United Nations World Health Organization (WHO) estimates that even under normal rainfall conditions, one billion people lack access to safe drinking water. There clearly is a need for reliable alternative sources of drinking water for both the developed and underdeveloped worlds.

As the Earth is 70% covered by water, the obvious solution would be to transform undrinkable seawater into potable water. Seawater “as is” is dangerous for consumption and large quantities can lead to serious health issues with changes in cellular osmotic pressure. Desalination, the process by which seawater is cleaned of its high salt content, is not a new concept. Desalination plants have been active in various parts of the world for fifty years and most naval and commercial ships have produced onboard drinking water through desalination since World War II. While there are more than 1,500 desalination plants in the world, desalinated water provides only a small fraction of the world's available fresh water supply. The question is why. There are several reasons.
(1) Desalinated water is not cheap. When one factors in the costs of building a facility, securing “beach-front” property near the seawater source and the energy required to drive reverse osmosis, distillation or other desalination processes, the cost of desalinated water is generally not competitive with water derived from lake or aquifer sources.
(2) Desalination is an environmentally-destructive process. Desalination generally leads to heating of both the product potable water as well as the waste brine. The latter is generally returned to the ocean. Hot brine can be devestating on sea flora and fauna. Returning brine in the general area of the intake pipes for a desalination plant can lead to more difficult and costly preparation of drinkable water due to the higher salt concentration in the source sea water.
(3) Desalination is generally a very local phenomenon. The location of a desalination plant defines the immediate reach of the final product drinking water due to the costs of piping such water long-distance. Alternative shipping or transport means are not economically feasible and as such desalination plants are very local in their contribution to totally available drinking water. This point was poignantly demonstrated when Israel signed a water purchase agreement with Turkey. Neither country could propose a cost-effective solution for transporting the inexpensive Turkish water to willing Israeli consumers.

One approach to overcome the issue of local production of drinking water has been to outfit a boat that could desalinate water and then send the clean drinking water to land for distribution. The advantages of a boat include flexibility in location as per need, responsiveness to disasters where drinking water is often one of the most urgent commodities, lower fixed costs due to an absence of ocean-front property for function, and stability in drinking water availability by adding to local resources as per specific demand and conditions. Though most sea-going vessels desalinatee water for internal consumption, to date, there has never been a fleet of ocean-going vessels dedicated to desalinated water delivery in addition to disaster relief and electric power delivery.

The concept of a “floating desalination plant” has been discussed for years. Lampe, et al. describe a system for converting a retired oil tanker as a platform for Peussag reverse osmosis (Desalination 114: 145-151 [1997]). Gordon, et al in U.S. Pat. No. 7,081,205 and Gordon in U.S. Pat. No. 7,306,724 describe a system for delivering desalinated water from a floating vessel. In their system they process the residual brine (“concentrate”) by mixing it with seawater to cool it and reduce its salt concentration prior to return of treated brine to the ocean. While their efforts may reduce the damage caused by the waste brine, they still return over-concentrated salts to the ocean and their vessel must have a significant volume set aside for mixing the millions of gallons of brine with sea water prior to ejection.

One remedy for brine disposal is to keep it on board or deliver it to land. While brine returned to the ocean can lead to both heating of the ocean and local hyperconcentration of salts, transferring the brine, at least in part, to land avoids both of these problems. The highly concentrated brine that is a necessary by-product in production of desalinated water by any method and could be used in several ways:
1. In appropriate countries, it could be dried down, with the resulting salt being sold as food-grade seasalt.
2. In some areas, the brine could be used to form a salt lake, similar to the Great Salt Lake or the Dead Sea, both of which are extremely positive tourist attractions and revenue-generating bodies of water.
3. Most importantly, the highly concentrated byproduct brine may be used for fuel. Scientist and inventor John Kanzius has described (http://peswiki.com/index.php/Directory:John_Kanzius_Produces_Hydrog en_from_Salt_Water_Using_Radio_Waves) the application of radio frequency (RF) waves to salt solutions, with the concomitant production of a flame that burns at 1500 degrees Centigrade. In the future, when Kanzius' technology becomes commercial, there will be a genuine need for highly concentrated salt water and the concentrated brine byproduct of desalination will be in great demand.

### SUMMARY OF INVENTION

The present invention provides for a floating desalination system that delivers drinking water and concentrated brine to a land-based holding system. Specifically, the invention includes a vessel, the vessel having the ability to produce and deliver desalinated water to shore with concomitant delivery of a portion of waste brine to a shore-based holding element.

Herewith is described a system for providing desalinated water and concentrated brine to shore including a vessel, said vessel having an intake pipe and being capable of producing desalinated water with delivery of desalinated water and a portion of the waste concentrated brine to a shore-based holding element.

In one aspect of the system, the vessel is a ship.

In still another aspect of the system, the vessel is a fixed offshore structure.

In yet another aspect of the system, at least five percent (5%) of the concentrated brine produced on the vessel is shipped to shore via a pipeline.

In a further aspect of the invention, the concentrated brine is used, at least in part, to power the vessel.

In still a further aspect of the invention, the concentrated brine is used, at least in part, to power an electricity-producing power plant.

In another aspect of the invention, the desalinated water is delivered to a shore-based holding system via a pipeline.

In still an additional aspect of the invention, the pipeline used in the delivery of a portion of the concentrated brine is made from a polymer.

In yet a further aspect of the invention, the vessel may transfer electricity via a transmission line to an inland power grid.

In one further aspect of the invention, the transmission line is realized as an insulated power cable run under the ocean.

The invention also includes a method for producing desalinated water and concentrated brine and shipping both separately to shore, including the steps: providing a vessel, the vessel being capable of producing desalinated water and concentrated brine; transferring desalinated water from the vessel to a shore-based holding tank or municipal water system; transferring a portion of the concentrated brine to a shore-based holding element; and, returning remaining concentrated brine to the sea.

In one aspect of the method, the vessel is a ship.

In another aspect of the method, desalinated water produced by the vessel is further purified prior to delivery of water to a shore-based holding tank.

In still another aspect of the method, electrical energy is produced by applying an RF signal to the concentrated brine. Such an application of RF signal may be performed either on the vessel or on land.

In yet another aspect of the method, application of the RF signal to concentrated brine leads to production of intense heat, the heat being used to heat water to high-temperature steam for powering of an electricity-generating turbine.

In still a different aspect of the method, electricity produced by applying an RF signal to the concentrated brine is shipped via a transmission line realized as a cable to a land-based electrical grid.

The invention also includes a system for producing electrical energy from desalination byproduct concentrated brine, including: a vessel, the vessel being capable of producing desalinated water and concentrated brine; and, a pipeline for transferring the concentrated brine to a shore-based holding element.

In one aspect of the system, the vessel is a fixed offshore structure.

In another aspect of the invention, the fixed offshore structure is in close proximity to a power plant.

In still another aspect of the invention, the system includes a source for RF signal.

### BRIEF DESCRIPTION OF THE DRAWINGS

FIG. 1 is a schematic summary of desalination and its products.

FIG. 2 is a schematic view of heat production resulting from an RF signal applied to a salt solution.

FIG. 3 is a schematic view of steam production through application of an RF signal to a salt solution.

FIG. 4 is a schematic view of a preferred embodiment of the present invention.

FIG. 5 is a schematic view of a preferred embodiment of the present invention in which product concentrated brine is used by a power plant for production of electricity.

FIG. 6 is a schematic view of a preferred embodiment of the present invention in which product concentrated brine is shipped to a power plant for production of electricity.

FIG. 7 is a schematic view of a preferred embodiment of the present invention in which electricity is shippped from a vessel to a land-based power-grid.

FIG. 8 is a schematic view of a preferred embodiment of the present invention in which a portion of concentrated brine produced by desalination vessel is transferred to a secondary vessel.

FIG. 9 is a schematic view of a preferred embodiment of the present invention in which a filter is placed on intake valve of vessel and a purification apparatus is attached to pipeline taking desalinated water from vessel to a shore-based holding tank.

FIG. 10 is a schematic view of a preferred embodiment of the present invention in which a land-based desalination system provides desalinated water for drinking and concentrated brine to a power plant for electricity production.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances alternative materials and physical arrangements from those described may be employed in the present invention. The unique aspect of the invention, independent of materials or specific embodiment, is the active use of “waste” concentrated brine from a sea-based desalination vessel. Concentrated brine is generally discarded in the ocean by one means or another. In the present invention, the concentrated brine is used, at least in part, for land-based storage or the generation of electrical power based on a recent discovery concerning heat generated from brine as a result of applying an RF signal to said brine.

### Definitions

To better understand the invention described in the present invention, certain terms are defined. Most definitions follow the normal meaning of the terms as used in the respective arts. Other terms unique to the present invention are defined for their specific meaning

A “vessel” or “desalination vessel” refers to a solid element that can rest in water without sinking. Examples of vessels include but are not limited to boats, ships, barges, seaplanes, as well as fixed structures like oil-rigs, fixed desalination plants and water-purification facilities.

A “secondary vessel” is a ship or other seaworthy element that can receive a portion of concentrated brine from a desalination vessel. A secondary vessel can travel freely on water from location to location.

“Desalination” has its normal meaning in the art. Desalination for the present invention may be performed by any method including but limited to reverse osmosis, distillation, centrifugation and evaporation/condensation. During desalination, drinking water is separated from sea water leaving behind seawater with an elevated salt concentration. “Concentrated brine” refers to the post-desalination residual seawater with increased salt concentration. Specifically, “concentrated brine” refers to the desalination product that is not drinkable due to its significantly heightened salt concentration. “Brine” and “seawater” have their normal meanings. “Brine” and “saltwater” are used interchangeably in the present invention.

“Pipe” and “pipeline” have their normal meaning. A pipe or pipeline according to the present invention may be made of any appropriate material including but not limited to polymers, plastic, stainless steel, concrete, rubber and glass. It may also be flexible and hose-like or rigid, free floating on the surface of water or submerged with concrete blocks on the sea floor.

“Intake pipe” refers to a pipe or other element that allows for intake of seawater by a vessel, the seawater being subject to a desalination process on the vessel.

“Holding tank” also referred to as a “storage facility” refers to a shore-based structure into which one may deliver desalinated water from a desalination vessel. The holding tank is constructed with materials and in such a manner so as to hold the desalinated water without risk of contamination to the desalinated water or damage to the holding tank.

“RF” and “radio frequency” have their normal meaning in the physical arts.

“Holding element” also referred to as a “storage element” refers to a shore-based structure into which one may deliver concentrated brine from a desalination vessel. The holding element is constructed with materials and in such a manner so as to hold the concentrated brine without risk of damage to either the holding element or the concentrated brine. Polymers are particular preferred for the internal portion of a holding element.

“Power plant” refers to a facility that produces electricity. A power plant may be located on a vessel or on land. Coal-fired electricity power plants are a non-limiting example of a power plant. A power plant according to the present invention may generate electricity by any means.

“Close proximity” with respect to a holding element for concentrated brine relative to an electricity-generating power plant is less than 5 kilometers.

“Portion” with respect to concentrated brine shipped to shore may be between 0.1% and 100% of concentrated brine produces during desalination. The actual portion of concentrated brine shipped to shore is determined based on specific needs for the concentrated brine.

### Specific Embodiments

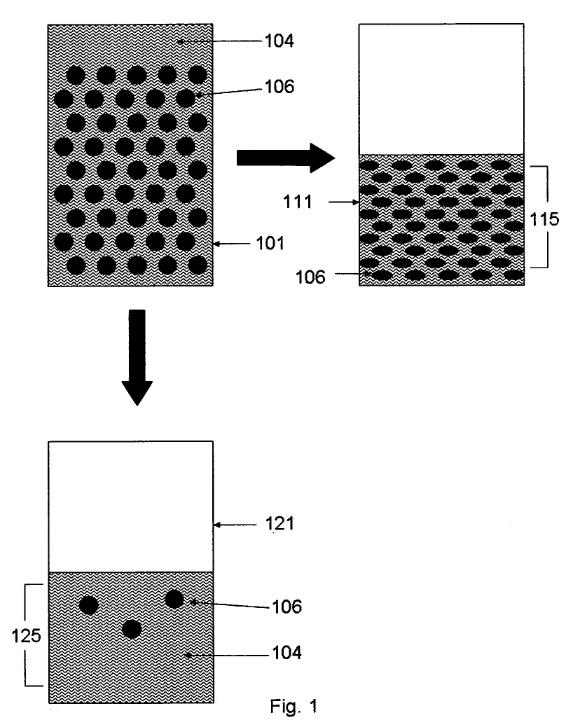

The invention described herewith has particular application for a desalination ship or sea-based structure. As noted in the sixth embodiment below, the same method may be applied to a land-based desalination system as well. So as to clarify the substance of the present invention, attention is turned to FIG. 1. FIG. 1 shows a container (101) holding seawater. Seawater is represented by its two main components, namely water (104, waves), and ions (106, all ions, regardless of charge). Note that the components of seawater are not shown to scale and are shown in schematic form for ease of understanding of the invention only. All desalination processes, independent of specific methodology, produce two products, as additionally shown in FIG. 1. In container 111 is shown concentrated brine (115), the “waste” product of desalination. In the container is water with a far-higher concentration of ions (106). This water is undrinkable, useless for agriculture, and if returned to the sea “as is” potentially dangerous to sea-based flora and fauna. Most desalination plants, both land- and sea-based, return the concentrated brine (115) in some form back to source sea. Return of concentrated brine (115) to the sea is deleterious to the well-being of ocean species and can make desalination more challenging as time passes due to a higher starting concentration of salt in seawater used for desalination.

In container (121) is product desalinated water (125). As shown, it contains primarily water (104) with very few remaining ions (106). The desalinated water (125) is appropriate for agricultural and human needs. The desalinated water (125) can be modified post-desalination by addition of other ions or vitaimins (not shown). Alternatively or additionally, desalinated water (125) can be sterilized or otherwised purified (see Embodiment 5 below) post-desalination.

Until now, desalinated water has been of limited use primarily due to its cost. Much expense and inefficiency is associated with waste concentrated brine (115) due to its uselessness. In U.S. Pat. No. 7,081,205, Gordon, et al. go to great lengths to dilute and cool waste concentrated brine before return of brine to sea. Additionally, they use sophisticated systems to disperse the cooled and diluted waste brine. Their brine disposal methods require large amounts of energy as well as valuable space on their desalination ship to accomplish their goals of diluting and returning waste brine. The space dedicated to diluting and cooling waste concentrated brine is space wasted from other valuable applications such as increased desalination capacity, storage of ready-to-eat meals or emergency shelters for disaster victims. As such, the space is wasted with respect to potentially alternative applications.

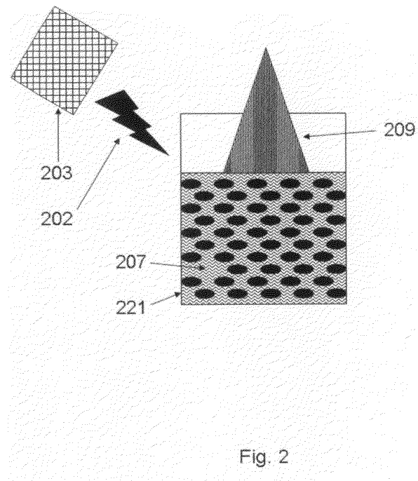

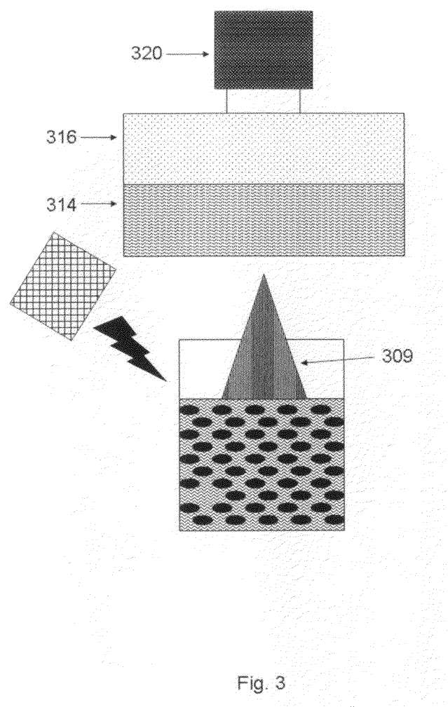

An invention by John Kanzius (Inventor on US Patent Application Numbers 20050251233; 20050251234; 20050273143; 20060190063; 20070250139) has provided the first hope for meaningful use of concentrated brine (115). Specifically, Kanzius has discovered that application of an RF signal (FIG. 2, 202) from an RF source (203) can cause saltwater (207) in a container (221) to produce a flame (209) of 1500 degrees Centigrade temperature (see reference above). According to Kanzius, the more concentrated the salt in solution, the more energy released (John Kanzius, personal communication). As shown in FIG. 3, flame (309) can heat water (314) to form high-temperature steam (316), the steam being capable of driving a turbine (320) for the production of electricity. Kanzius' discovery and the availability of concentrated brine as a byproduct of desalintion means that desalination may go beyond providing water to those in need. It may additionally lead to cheap electricity production via Kanzius' method of applying an RF signal to concentrated brine.

### First Embodiment

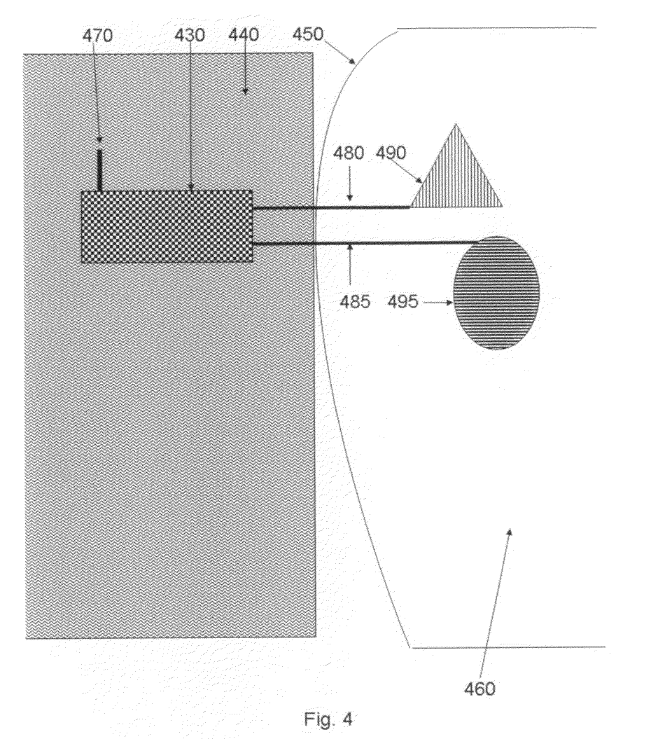

Attention is now drawn to FIG. 4 which shows a schematic view of a preferred embodiment according to the present invention. Specifically, vessel (430) is at sea (440) off the shore (450) of a land region (460). The vessel (430) is equipped with an intake pipe (470) that allows for intake of seawater into the vessel. In the vessel (430), seawater from the intake pipe (470) is desalinated by any method of desalination including but not limited to reverse osmosis, distillation and evaporation/condensation (not shown). Desalination produces desalinated water and concentrated brine. Desalinated water may be stored on vessel (430) but is generally shipped by a pipeline (480) to a storage facility (490) or municipal water system (not shown) inland from the shore (450). Concentrated brine, in part, is shipped via a separate pipeline (485) to a storage element (495) that can be in the sea or on land as shown in FIG. 4. The amount of concentrated brine shipped by pipeline (485) to storage element (495) is determined by the final use of the concentrated brine. Generally, 5% or more of concentrated brine is shipped to shore. The remainder is dispersed in the sea (440) by any known dispersion means.

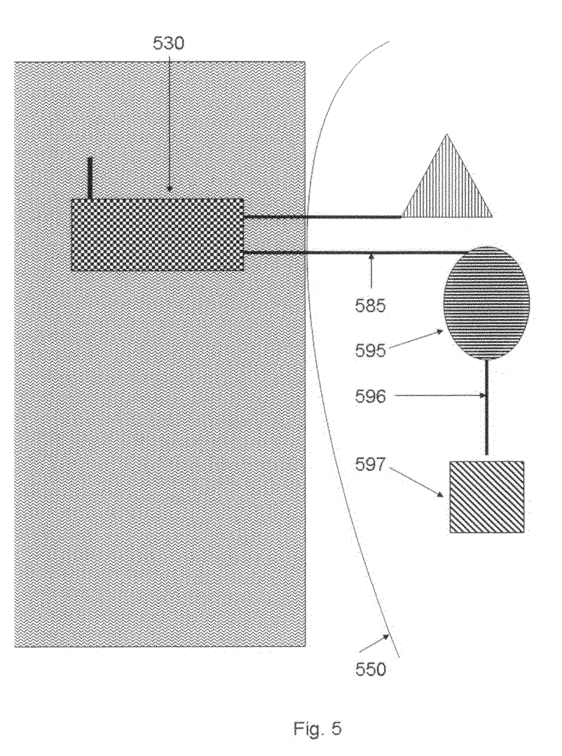

Attention is now turned to FIG. 5, which is a schematic view of a preferred embodiment according to the present invention. In this embodiment, vessel (530) produces concentrated brine and ships the same via a pipeline (585) to a storage element (595) beyond the shore (550). The storage element (595) is in close proximity to a power plant (597) that runs on RF-generated power from concentrated brine, as previously described. A pipeline (596) allows for transfer of concentrated brine between storage element (595) and power plant (597) as per fuel needs of the power plant (597).

### Second Embodiment

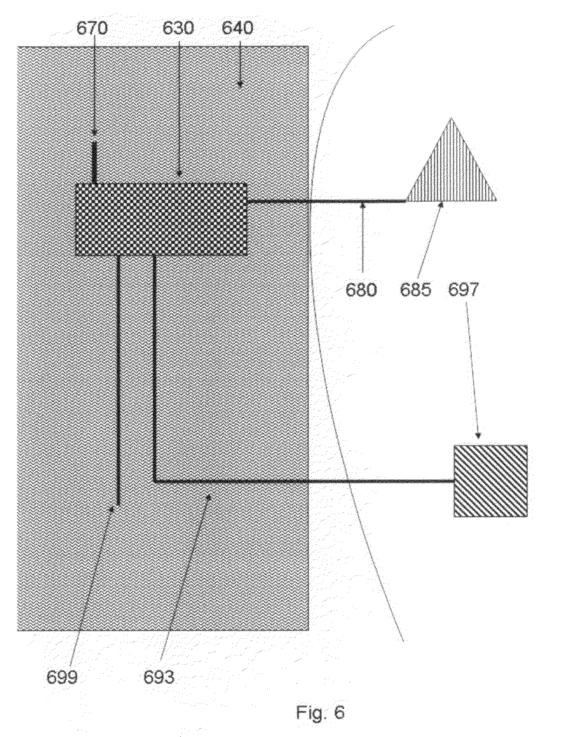

In FIG. 6, an alternative preferred embodiment of the present invention is presented. Vessel (630) is a fixed structure in the sea (640) and has an inlet pipe (670) for seawater. The vessel (630) can produce both desalinated water for human consumption and concentrated brine for electricity production. As shown, a pipeline (680) takes desalinated water to an on-shore holding tank (685), while a separate pipeline (693) takes a portion of concentrated brine directly to a power plant (697). A runoff pipe (699) removes remaining concentrated brine from the vessel (630) and returns it to the sea (640) at a distance of 1 kilometer from the position of the vessel (630).

### Third Embodiment

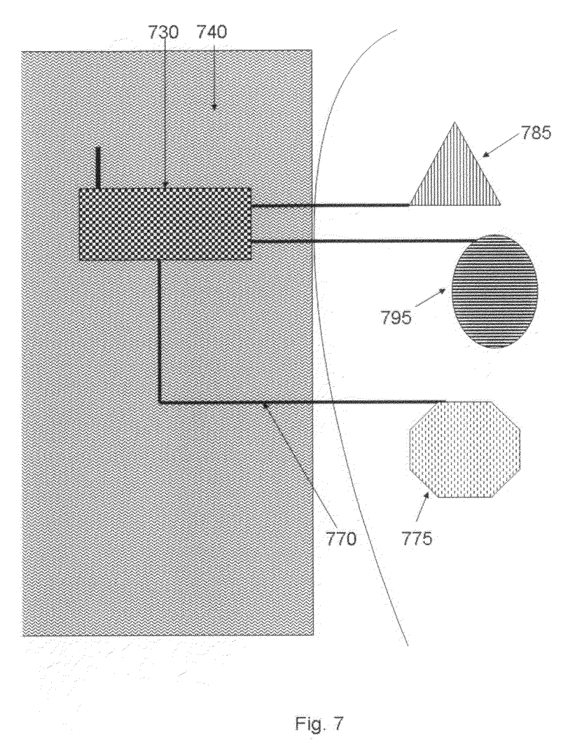

The embodiment shown schematically in FIG. 7 shows a vessel (730) at sea (740) that delivers desalinated water to a shore-based holding tank (785) and concentrated brine to a holding element (795). Additionally, the vessel (730) can deliver electricity via a a transmission line (770) to a land-based power grid (775). After many natural disasters, such as Hurricane Katrina in New Orleans, drinking water and electricity are two of the most pressing needs of those affected. The vessel (730) is outfitted for land-based delivery of potable water and concentrated brine in addition to electricity. The vessel (730) itself additionally carries thousand of ready-to-eat meals and can provide temporary emergency shelters to hundreds or potentially thousands of displaced people.

### Fourth Embodiment

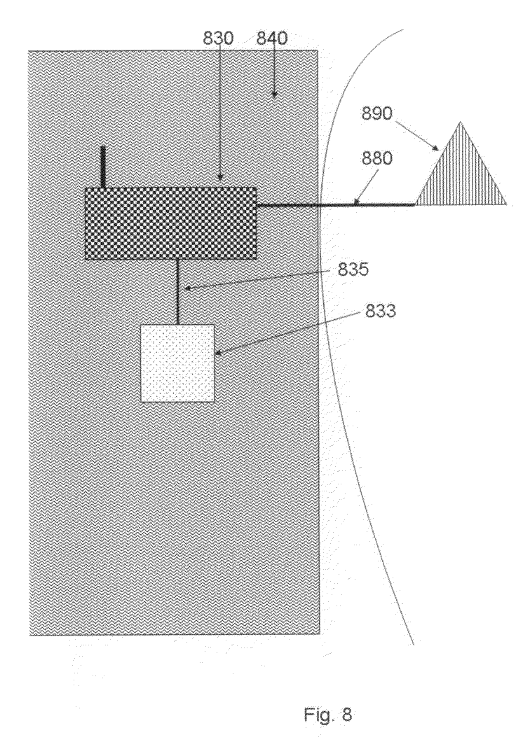

In a preferred embodiment of the present invention schematically represented in FIG. 8, desalination vessel (830) at sea (840) produces desalinated water which is shipped by pipeline (880) to a holding tank (890). Additionally, the vessel (830) can transfer concentrated brine to a second vessel (833) via a pipe (835). In this embodiment, an electricity-producing power station is not in close proximity to the site of desalination. A desalination ship (830) will always travel to a location that is in close proximity to needed potable water. Concentrated brine, like coal, on the other hand may be shipped via a second vessel (833) over long distances to a power plant site (not shown).

### Fifth Embodiment

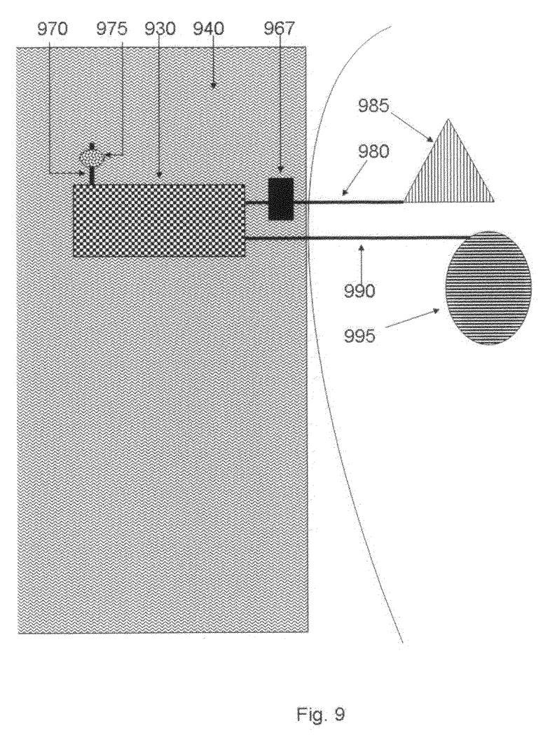

In the preferred embodiment of the instant invention schematically represented in FIG. 9, water quality is addressed before and after salination. A desalination vessel (930) has an intake pipe (970) that includes a filter (975), said filter removing all solid and large particulate matter from the sea water. The filter (975) is selected with a pore-size or cutoff range to allow for effective intake of seawater (940) into the desalination vessel (930) for efficient desalination. The filter (975) is shown as a part of the pipeline (970) for convenience of visualization only. It may alternatively be associated with or integrated into the desalination vessel (930). Desalinated water leaving the desalination vessel (930) travels via a pipeline (980) to an on-land holding tank (985). A water purification element (967) treats desalinated water. The water purification element (967) can kill bacteria either through treatment with UV light or chemicals. The water purification element (967) can additionally alter the pH of the desalinated water, filter the desalinated water or add minerals or vitamins. The water purification element (967) is shown as a part of the pipeline (980) for convenience of visualization only. It may alternatively be associated with the desalination vessel (930), the holding tank (985) or be integrated into an land-based water distribution system (not shown). Concentrated brine produced by desalination vessel (930) and delivered to a holding element (995) via a dedicated pipeline (990) does not require filtering or other post-desalination treatments or modifications.

### Sixth Embodiment

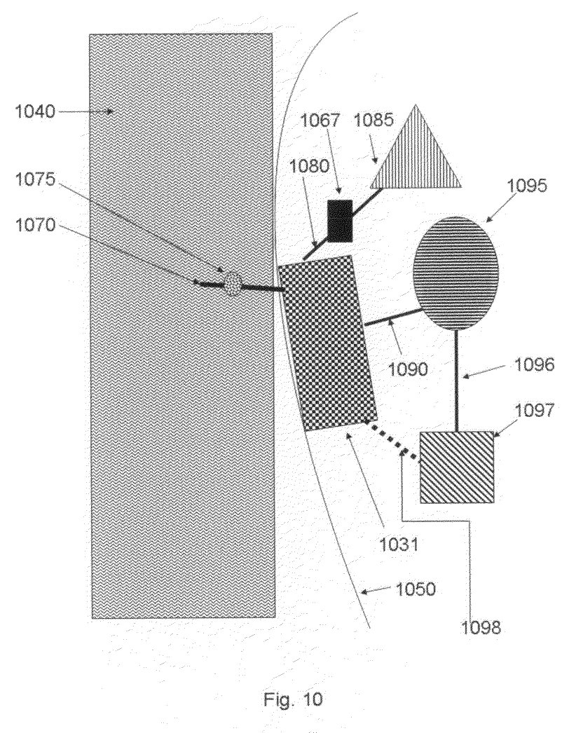

A preferred embodiment of the present invention is shown schematically in FIG. 10. In this embodiment, a land-based desalination plant (1031) has an intake pipe (1070) with an intake filter (1075). The desalination plant (1031) is located on-land near a shore (1050) of an ocean (1040). The desalination plant (1031) produces desalinated water from ocean (1040) water and delivers said desalinated water via a pipeline (1080) to a holding tank (1085). A water purification element (1067) purifies desalinated water from the desalination plant (1031) prior to the water's delivery to a holding tank (1085) via a pipeline (1080). Concentrated brine produced during desalination in the desalination plant (1031) is transferred via a pipeline (1090) to a holding element (1095). A second pipeline (1096) can take the concentrated brine from the holding element (1095) to a power plant (1097) in close proximity. Alternatively, the concentrated brine may be delivered directly from the desalination plant (1031) to the power plant (1097) via a direct pipeline (1098).

### EXAMPLE 1

A seaworthy vessel is selected for desalination according to reverse osmosis. Typical principal dimensions and storage capacities of a converted vessel are as follows: Length Overall (LOA): 274 m; Breadth: 32.00 m; Depth: 24.00 m; Draft: 16.00 m. A standard bulk carrier hull form is most ideal for a floating desalination and power plant. For example: Gearless Capesize Bulk Carrier (NV Class/Main Eng: Sulzer 27000 BHP: TDW: 148,140; Draft: 15.92; Built in Japan 1986). The vessel can house a crew compliment of 22. Standard crew quarters, eating, sanitary and recreational facilities are provided. The vessel includes a large space for the storage of membrane and chemical inventory, mechanical spare parts and emergency response equipment including plastic bags for liquid transport and storage, military food rations and blankets. Storage capacities include: Cargo Holds: 166,000 m3, Fresh Water: 450 m3, Heavy Fuel Oil: 4.600 m3; Marine Diesel Oil: Approx. 400 m3; Water Ballast: Approx. 57.000 m3; Permeate Holding Tanks: 2.000 m3. Additionally, 2,000 m3 of desalinated water may be stored onboard for quality assurance testing, onboard usage and compensation for flow fluctuations in potable water supply.

Intake System—Seawater is taken through sea chests at the bow of the vessel and passes through a filter. The seawater supply pumps elevate the pressure of the seawater sufficiently to pass it through the pre-filtration treatment process. It uses the same piping material as the Pipe for Water Transmission System (described below). Seawater thus taken in is next filtered and then desalinated by reverse osmosis.

Pre-Filtration Treatment System—Reverse osmosis (RO) membranes are at the heart of the desalination process. RO membranes are able to prevent the passage of very small ions such as those of salts found in seawater. But they are highly susceptible to fouling by the organics and other colloidal matter commonly found in seawater. In fact the most critical step in the success of an RO system is usually the effectiveness of its pretreatment system. Pre-treatment of the feed water is needed in order to extend membrane life and optimize membrane performance. Advanced UF membranes use compact bundles of thousands of hollow fine fibers to remove particles, bacteria and viruses greater than 0.01 μm in a single step to produce high quality water. These cutting edge UF membranes feature a highly compact design, resulting in a very small footprint. This has major advantages in a desalination vessel where space is very scarce and expensive. The UF have to be regularly back-washed with filtered seawater and scour air from the bottom to the top, the effluent being discharged into the sea. The swaying of the ship, caused by heavy seas or stormy winds must not influence the process. Using pressure UF filters instead of open filters, can minimize swaying influences. Other pre-treatment steps are considered: dosage of acid to remove bicarbonate ions followed by aeration and to remove carbon dioxide; cartridge filtering of particles obtained by oxidation of metal ions, de-chlorinating using sodium-bi-sulphite to remove residual free chlorine, active carbon to remove dissolved organic materials and chlorine compounds. Different antiscalants are used in order to prevent precipitation of least soluble salts. Some relatively small molecules like carbon dioxide, hydrogen sulphide, silica and boric acid may permeate and pollute the product quality. A feed water dump valve is positioned downstream of the monitoring equipment to divert the pretreated feed water to the sea if one of the measured parameters does not comply with operating guidelines.

Reverse Osmosis System—The feed water is pumped through the membranes with sufficient pressure and 40% of the feed water being converted into potable desalinated water with the rest as concentrated brine. Desalinated water is treated (see below) and shipped via pipeline to a municipal water system. The concentrated brine passes through energy recovery turbines, which can reduce the overall energy requirement by approximately 35%. The concentrated brine is then partially transferred to shore via pipelines and the balance is discharged back into the ocean. Concentrated brine may alternatively be shipped directly to a power plant or off-loaded to a second vessel, said second vessel taking the concentrated brine to shore. Chemical cleaning of the RO racks is performed regularly in order to reestablish the initial plant performance. Given its considerable size and available space, the vessel can deploy multiple iterations of reverse osmosis plants such as those manufactured by Siemens (Vantage H series) and General Electrics (SWRO series). As described, the present invention may employ reverse osmosis or any other method of desalination. Prior to delivery of desalinated water to a municipal water system, the water is treated.

Post-RO Treatment System—Disinfectant and lime are added downstream of the vessel desalinated water tank for disinfections, pH adjustment and passivation. A water purification element will also process the desalinated water using Ultraviolet lighting (i.e. TrojanUV3000 Plus—www.troianUV.com) After UV disinfection, desalinated water is potable water and may thus be sent by pipeline to shore.

Pipe for Water Transmission System—The vessel will deliver water that fully meets the WHO drinking water standards. Full details are available at: http://www.who.int/water_sanitation_health/dwq/gdwq3rev/en/index.html. The vessel will be designed to deliver 150,000 m3/day permeate. The vessel will connect to beach by pipeline, partly in polyethylene (PE) partly in rubber and of suitable dimension. This pipeline will be towed air-filled to site by vessel and deployed on the sea bed. At the beach the pipe will be connected to a holding tank or a local distribution system and water mains or, in case absent (i.e. emergent need situation), a simple distribution cauldron may be deployed. For example: PE OD 1,000 mm high density polyethylene (HDPE) pipes for marine aconstruction (i.e those manufactured by Pipelife Norge AS—www.pipelife.com), with flexible rubber hoses at either end and pullhead, flanges, valves, ship connection units (i.e those manufactured by Plastek), anchors and a permanent distribution tank at beach (i.e. corrugated tank by BH Tank—www.bhtank.com) or a temporary distribution tank for emergencies (Alligator L Tank—www.albersalligator.com/getme.php?site_ID=222&pageid=2391).

Pipe for Brine Water Transmission System—The vessel can also deliver 11,250 m3/day of concentrated brine to shore via a second pipeline.

### EXAMPLE 2

A desalination facility is built on the California shore of the Pacific Ocean. The facility can produce 5 million gallons a day of desalinated drinking water that is added to the local water distribution system. It produces an additional 5 million gallons a day of concentrated brine that is left over from desalinated salt water. The concentrated brine is shipped 400 meters to a nearby electricity power plant that applies RF signal to brine to generated heat. The heat turns water into high-energy steam, the latter being capable of spinning a turbine for electricity production. In this example, raw seawater is converted to drinking water and concentrated brine, said brine being an ideal non-fossil fuel for electricity production.

### EXAMPLE 3

A desalination vessel is supplied. The vessel has the following non-limiting features:
1. Intake System
2. Pre-Filtration System
3. Desalination System (reverse osmosis)
4. Post-RO Treatment System
5. Desalinated Water Transmission System to land
6. Brine Transmission System to land and sea
7. Pumps
8. On-Board power plant
9. Holding tanks and other storage holds
10. On-Board crew quarters, mess hall, kitchen, entertainment areas
11. Engine
12. Helipad
   The vessel is available for UN-initiated disaster relief response. As the ship can provide potable water and electric power, the vessel is ideal for rapid-response to sudden devastation such as that which occurs after hurricanes, tsunamis and the like.

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. The desalination system described herewith is unique in that it is the first to invoke a commercial use of concentrated brine, the normal waste byproduct of desalination. By providing highly concentrated brine for commercial power production or other uses, the present invention makes desalination an economically-viable method of drinking water production and delivery.

1. A system for providing desalinated water and concentrated brine from sea to shore including:
a vessel, said vessel being capable of producing desalinated water and concentrated brine; an intake pipe;
a pipe for delivering desalinated water to a land-based holding tank; and,
a pipe for delivering a portion of said concentrated brine to a land-based holding element.

2. The system according to claim 1, wherein said vessel is a ship.

3. The system according to claim 1, wherein said vessel is a fixed structure.

4. The system according to claim 1, wherein, said portion is 5% of total concentrated brine produced.

5. The system according to claim 1, wherein said concentrated brine is used to power said vessel.

6. The system according to claim 1, wherein said concentrated brine is used to power a power plant.

7. The system according to claim 1, wherein said vessel delivers said desalinated water to shore.

8. The system according to claim 6, wherein said vessel delivers said concentrated brine directly to said power plant.

9. The system according to claim 1, wherein said vessel can additionally deliver electrical power to a land-based electrical grid.

10. The system according to claim 9, wherein said electricity is delivered to shore via an electrical cable.

11. A method for delivering desalinated water and concentrated brine separately to shore, including:
providing a vessel, said vessel being capable of producing desalinated water and concentrated brine;
transferring desalinated water from said vessel to a shore-based holding tank;
transferring a portion of said concentrated brine to a shore-based holding element; and,
returning remaining concentrated brine to the sea.

12. The method according to claim 11, wherein said vessel is a ship.

13. The method according to claim 11, further including the step of purifying said desalinated water prior to delivery of said desalinated water to said holding tank.

14. The method according to claim 11, with the additional step of generating electricity from said concentrated brine through application of an RF signal to said concentrated brine.

15. The method according to claim 14, wherein said step of generating electricity from said concentrated brine occurs on said vessel.

16. The method according to claim 15, wherein said electricity is shipped to a shore via a transmission wire.

17. A device for the production of electrical power from concentrated brine, including:
a vessel, said vessel capable of producing desalinated water and concentrated brine;
a pipeline for transferring said concentrated brine to a shore-based holding element; and
a power generation facility in proximity to said holding element, wherein said power generation facility converts said concentrated brine into electrical energy.

18. The device according to claim 17, wherein said vessel is a fixed structure.

19. The device according to claim 17, wherein said holding element is in close proximity to a power station.

20. The device according to claim 17, further including a source for RF signal.

21. A system for providing desalinated water and concentrated brine for the creation of an artificial salt lake, including:
a vessel, said vessel being capable of producing desalinated water and concentrated brine;
an intake pipe;
a pipe for delivering desalinated water to a land-based holding tank; and,
a pipe for delivering a portion of said concentrated brine to a land-based location of said artificial salt lake.

22. The system according to claim 21, wherein said vessel is a ship.

23. The system according to claim 21, wherein said vessel is a fixed structure.

24. The system according to claim 21, wherein, said portion is 10% of total concentrated brine produced.

25. The system according to claim 21, wherein said concentrated brine is delivered directly to a site for creation of said artificial salt lake.

26. A method for delivering brine to shore for the production of table salt, including the following steps:
providing a vessel, said vessel being capable of producing desalinated water and concentrated brine;
transferring desalinated water from said vessel to a shore-based holding tank;
transferring a portion of said concentrated brine to a shore-based holding element; and,
drying said concentrated brine to yield edible sea-salt.

27. The method according to claim 26, wherein said vessel is a ship.

28. The method according to claim 26, further including the step of separating chemicals from said edible sea-salt for separate recovery and sale.

29. The method according to claim 26, with the additional step of generating electricity from a portion of said concentrated brine through application of an RE signal to said concentrated brine.

30. The method according to claim 26, wherein said step of transferring a portion of said concentrated brine to a shore-based holding element is performed through the agency of a salt corrosion-resistant pipe.
